(19) United States
(12) Patent Application Publication
(10) Pub. No.: US 2005/0196559 A1
(43) Pub. Date: Sep. 8, 2005

(54) Ink jet recording sheet

(76) Inventors: Jun Nishio, Nishinomiya-shi (JP); Tetsuo Tsuchida, Takarazuka-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/070,523

(22) Filed: Mar. 2, 2005

(30) Foreign Application Priority Data
Mar. 5, 2004 (JP) 2004-061614
Feb. 2, 2005 (JP) 2005-026539

(51) Int. Cl. B41M 5/00

(52) U.S. Cl. 428/32.34

(57) ABSTRACT

An ink recording sheet having a stable ink receiving layer which eliminates problems of cracks generated on the ink receiving layer, and which is also excellent in glossiness, ink absorptivity, image quality, and long-term preservability. The ink jet recording sheet includes a supporting medium, and an ink receiving layer including an inorganic fine particle, a cationic polymer, and a binder. The ink receiving layer is disposed on the supporting medium, wherein the average primary particle size of the inorganic fine particle is 30 nm or less, and the cationic polymer is a polymer (A) including: at least one structural unit (a1) expressed by a following general formula (1) or (2): 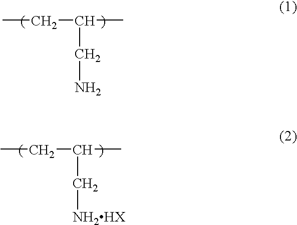
wherein X represents an acid residue; and at least one structural unit (a2) expressed by a following general formula (3): 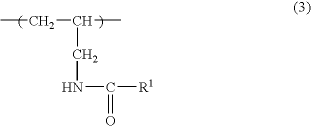
wherein R¹ represents a C₁₋₁₈ alkyl group, C₁₋₁₈ alkoxy group, C₆₋₁₂ aryl group, or benzyl group.

Priority is claimed on Japanese Patent Application No. 2004-061614, filed Mar. 5, 2004, and Japanese Patent Application No. 2005-026539, filed Feb. 2, 2005, the contents of which are incorporated herein by reference.

### BACKGROUND OF THE INVENTION

1. Field of the Invention

The present invention relates to an ink jet recording sheet having an ink receiving layer, which includes inorganic fine particles, cationic polymer, and binder, disposed on a supporting medium.

2. Description of Related Art

Ink jet recording systems in which aqueous ink is ejected through a nozzle having fine pores to form an image on a recording medium is widely used in terminal printers, facsimiles, plotters, sheet feeding printers, etc., due to low noise during recording, ease of performing color recording, possibility of performing high-speed recording, lower cost than other printing devices, and so forth. Recently, demand has also increased for high performance of recording media used in ink jet recording systems due to increasing widespread use of printers and development thereof to enhance high definition and high-speed performance as well as appearance for digital cameras in the field. That is, recording medium having excellent recording properties including a high ink absorptivity, a high recording density, a high water resistance and preservability, and a high image quality equivalent to a silver halide photograph is strongly desired.

In order to improve ink absorptivity, recording density, and image quality, a method has been proposed in which inorganic fine particles, such as those of amorphous silica, is disposed, as an ink receiving layer, on a supporting member together with a binder. Also, a method in which synthesized silica fine particles are used in an ink receiving layer in order to improve glossiness and image quality of a recording medium has been proposed.

Moreover, methods have been proposed in which various additives are added to improve the preservability of an image, such as a method in which at least one of metallic oxide, metallic chloride, and tannic acid, such as phosphotungstic acid, phosphomolybdic acid, and chromic chloride, is added, a method in which antioxidant, such as a hindered phenol, is added, a method in which ultraviolet absorbent, such as a benzophenone, a benzotriazole and a phenylsalicylic acid, is added, a method in which a thiourea compound is added, a method in which a particular mercapto compound, such as 2-mercapto benzothiazole and 2-mercaptobenzimidazole, is added, a method in which dithiocarbamate, thiuramate, thiocyanic ester or thiocyanate is added, a method in which basic polyalminium hydroxide is added, and a method in which zirconyl oxychloride type active inorganic polymer is added.

Furthermore, methods have been proposed in which cationic polymer or basic latex is included in the ink receiving layer in order to improve the recording density or the water resistance of an image. As an example of the cationic polymer, a primary amine polymer having a structural unit derived from a primary amine, such as monoallyl amine, a secondary amine polymer having a structural unit derived from a secondary amine, such as diallyl amine, a quaternary ammonium polymer having a structural unit derived from a quaternary ammonium compound, such as diallyldimethylammonium chloride, and a primary amine/secondary amine copolymer having a structural unit derived from monoallyl amine salt and diallyl amine salt have been proposed (for example, refer to Japanese Laid-Open Patent Application No. Sho 60-83882, Japanese Laid-Open Patent Application No. Sho 61-61887, Japanese Laid-Open Patent Application No. Sho 62-238783, and Japanese Laid-Open Patent Application No. 2000-211235).

However, although full-color ink jet recording images formed by using ink jet recording sheets disclosed in Japanese Laid-open Patent Application No. Sho 60-83882, Japanese Laid-open Patent Application No. Sho 61-61887, or Japanese Laid-open Patent Application No. Sho 62-238783 has high printing density and coloring properties, and is excellent in water resistance and light resistance of an image, it is not sufficient for glossiness, ink absorptivity, image quality, long-term preservability, and in particular, preservability under high temperature and humidity environments (high temperature and humidity resistance) of the ink jet recording sheet.

Also, full-color ink jet recording image formed by using ink jet recording sheet disclosed in Japanese Laid-open Patent Application No. 2000-211235 has problems in high temperature and humidity resistance, light resistance, ozone resistance, and so forth similar to that disclosed in Japanese Laid-open Patent Application No. Sho 60-83882, and the ink absorptivity thereof is also insufficient.

Moreover, the surface of ink receiving layer of the ink jet recording sheet obtained by using the above technique tends to be easily cracked, and hence, has problems in that the glossiness of the sheet decreases and the quality of the image is deteriorated. Furthermore, the state of a coating solution for forming an ink receiving layer (i.e., an ink receiving layer coating solution) may sometimes be unstabilized and the viscosity thereof may be increased or even the solution may even be aggregated. At that time, problems may occur during production, and cracks may be caused in the ink receiving layer or the glossiness thereof may be deteriorated.

### SUMMARY OF THE INVENTION

Accordingly, an object of the present invention includes to provide an ink jet recording sheet in which the coating solution for forming the ink receiving layer is exceptionally stable so that the problem of cracks generated on the ink receiving layer is significantly reduced, and is excellent in all of glossiness, ink absorptivity, image quality, and long-term preservability.

The inventors of the present invention found that the glossiness, ink absorptivity, image quality, and so forth may be improved by using inorganic fine particles having an average primary particle size of 30 nm or less as inorganic fine particles to be included in an ink receiving layer.

However, when such an inorganic fine particle is used in combination with cationic polymer, aggregation of the inorganic fine particle or increase in viscosity of the coating solution is caused. Accordingly, lowering in printing density and cracks on an ink receiving layer, which are conventionally observed, are more markedly caused, and as a result, problems, such as lowering in glossiness and in image quality, are caused. Also, with regard to the long-term preservability of an image, in particular to the high temperature and humidity resistance and light resistance, sufficient improvement thereof cannot be obtained.

The inventors of the present invention have found, after diligent research, that the above problems may be solved by using an inorganic fine particle having an average primary particle size of 30 nm or less in combination with a cationic polymer having a particular structural unit, and have completed the present invention.

Accordingly, the present invention includes the following aspects:

(1) Ink jet recording sheet which includes: a supporting medium; and an ink receiving layer including an inorganic fine particle, a cationic polymer, and a binder, the ink receiving layer being disposed on the supporting medium, wherein the average primary particle size of the inorganic fine particle is 30 nm or less, and the cationic polymer is a polymer (A) including: at least one structural unit (a1) expressed by a following general formula (1) or (2): 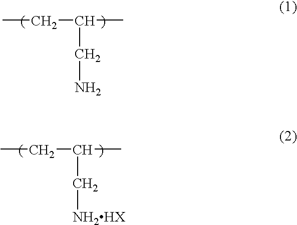
wherein X represents an acid residue; and at least one structural unit (a2) expressed by a following general formula (3): 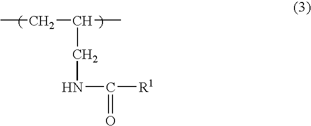
wherein R¹ represents a C₁₋₁₈ alkyl group, C₁₋₁₈ alkoxy group, C₆₋₁₂ aryl group, or benzyl group.

(2) The ink jet recording sheet according to (1), wherein the molar ratio of the structural unit (a1) to the structural unit (a2) in the polymer (A) is within a range of 0.5:1 to 20:1.

(3) The ink jet recording sheet according to (1) or (2), further including at least one structural unit (a3) expressed by following general formula (4), (5), (6) or (7): 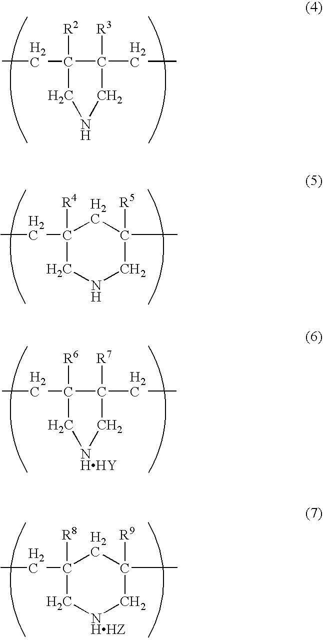
wherein R² to R⁹ each independently represents a hydrogen atom or an alkyl group having a number of carbon atoms of 1 to 4, and Y and Z independently represents an acid residue.

(4) The ink jet recording sheet according to (3), wherein a molar ratio of the total of the structural unit (a1) and the structural unit (a2) to the structural unit (a3) is 0.5:1 to 5:1.

(5) The ink jet recording sheet according to (3) or (4), wherein R² to R⁹ in the above general formulae (4), (5), (6) and (7) all represent hydrogen atoms.

(6) The ink jet recording sheet according to any one of (1)-(5), wherein the molecular weight of the polymer (A) is within the range between 10,000 and 200,000.

(7) The ink jet recording sheet according to any one of (1)-(6), wherein the inorganic fine particle is a vapor phase silica.

(8) The ink jet recording sheet according to any one of (1)-(6), wherein the inorganic fine particle is a wet process fine silica prepared by condensing active silicate.

(9) The ink jet recording sheet according to (8), wherein a specific surface area measured by a BET method and a pore volume of the wet process fine silica is 100 to 400 m²/g and 0.5 to 2.0 ml/g, respectively.

(10) The ink jet recording sheet according to any one of (1)-(9), wherein the ink receiving layer further includes a cross-linking agent.

(11) The ink jet recording sheet according to (10), wherein the cross-linking agent includes a boron compound.

(12) The ink jet recording sheet according to (11), wherein a mass ratio of the boron compound to the polymer (A) in the ink receiving layer is 1:1 to 1:10.

(13) The ink jet recording sheet according to any one of (1)-(12), wherein the ink receiving layer further includes a hindered amine photostabilizer containing a polymer (B) including: at least one structural unit (b1) expressed by the following general formula (8) and at least one structural unit (b2) expressed by the following general formula (9) and/or (10): 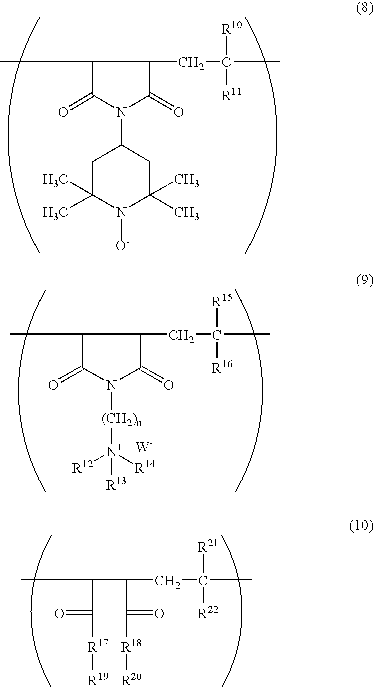
wherein R¹⁰, R¹¹, R¹⁵, R¹⁶, R²¹, and R²² each independently represents a hydrogen atom or a C₁₋₈ alkyl group, R¹² to R¹⁴ each independently represents a C₁₋₈ alkyl group, W represents an acid residue, and n represents an integer of 1 to 6; R¹⁷ and R¹⁸ each independently represents an oxygen atom or a N—R²³ where R²³ is a hydrogen atom or a C₁₋₈ alkyl group; and R¹⁹ and R²⁰ each independently represents a hydrogen atom or a C₁₋₈ alkyl group.

(14) The ink jet recording sheet according to (13), wherein the structural unit (b2) is expressed by the following general formula (11): 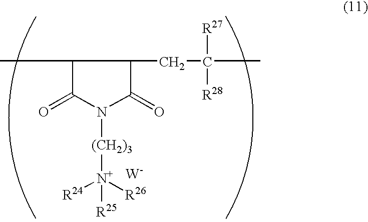
wherein R²⁷ and R²⁸ each independently represents a hydrogen atom or a methyl group; R²⁴ to R²⁶ each independently represents a C₁₋₃ alkyl group; and W represents an acid residue.

(15) The ink jet recording sheet according to any one of (1) to (14), wherein the supporting medium is a water resistant supporting medium.

(16) The ink jet recording sheet according to (15), wherein the water resistant supporting medium is a paper medium at least one surface of which is coated by a polyolefin resin.

(17) The ink jet recording sheet according to any one of (1)-(16), wherein the ink receiving layer is subjected to a cast process.

(18) The ink jet recording sheet according to any one of (1)-(17), further including a glossy layer which may be cast processed and is disposed on the ink receiving layer.

(19) The ink jet recording sheet according to any one of (1)-(18), wherein the ink receiving layer is made of a plurality of layers including: at least one inside layer including an inorganic fine particle and a binder; at least one aqueous coating layer formed on the inside layer by applying an aqueous solution including a cationic polymer on the inside layer; and at least one outside layer disposed on the aqueous coating layer.

(20) The ink jet recording sheet according to (19), wherein the aqueous solution further includes a cross-linking agent.

(21) The ink jet recording sheet according to (19) or (20), wherein the cation polymer is the polymer (A).

### DETAILED DESCRIPTION OF THE INVENTION

The invention summarized above and defined by the enumerated claims may be better understood by referring to the following detailed description. This detailed description of particular preferred embodiments, set out below to enable one to build and use particular implementation of the invention, is not intended to limit the enumerated claims, but to serve as particular examples thereof.

Hereinafter, the present invention will be explained in detail.

The ink jet recording sheet of the present invention has an ink receiving layer which includes inorganic fine particle, cationic polymer, and binder disposed on a supporting medium.

<<Supporting Medium>>

As a supporting medium, a known medium for conventional ink jet recording sheet may be suitably used.

More specifically, examples of the supporting medium includes paper (acidic paper, neutralized paper, etc.), baryta paper, synthetic paper, a plastic film, a supporting medium in which one or both surfaces of paper are covered by plastic (RC paper), and a medium in which nonwoven fabric or plastic film is adhered to one or both surfaces of paper via adhesive.

Examples of the plastic film include polyolefin resins, such as polyester and polypropylene, films, such as nylon, and synthetic paper.

Among these, in order to obtain clear image of high density, it is preferable to use water resistant supporting medium which does not permeate ink.

As a water resistant supporting medium, one in which both surfaces of paper is coated by polyolefin resin is preferably used since its recording image is similar to a photographic image and a high quality image may be obtained at low cost.

Also, as will be explained later, it is possible to preferably use an absorptive supporting medium, such as paper (acidic paper, neutralized paper, etc.), coated paper and baryta paper if the ink receiving layer is subjected to a cast process or a cast-processed glossy layer is disposed on the ink receiving layer. It is easy to subject the absorptive medium to the cast process since water components in the ink receiving layer coating solution are evaporated through the medium during the cast process. Moreover, such supporting medium is excellent in ink absorptivity and ink drying property as well as fast-speed printing.

Although the thickness of the supporting medium is not particularly limited, it is preferably 100 to 400 μm, for example.

<<Ink Receiving Layer>>

<Inorganic Fine Particle>

According to the present invention, the ink receiving layer includes inorganic fine particles having an average primary particle size of 30 nm or less. By including the inorganic fine particle having an average primary particle size of 30 nm or less, an ink receiving layer having high transparency and excellent in print density, glossiness, and ink absorptivity may be obtained. The primary particle size of the inorganic fine particle is more preferably between 3 to 15 nm.

Note that the term “primary particle size” used in the present specification means a particle size (Martin's diameter) observed by electron microscope (SEM and TEM).

Examples of materials for the inorganic fine particle contained in the ink receiving layer include zeolite, precipitated calcium carbonate, heavy calcium carbonate, magnesium carbonate, kaolin, talc, calcium sulfate, barium sulfate, titanium oxide, zinc oxide, zinc sulfide, zinc carbonate, satin white, aluminum silicate, diatomaceous earth, calcium silicate, magnesium silicate, silica, aluminum hydroxide, alumina, hydrated alumina, alumino silicate, boehmite, and pseudoboehmite. Among them, silica, alumina, hydrated alumina, and alumino silicate are preferable from the viewpoint of ink absorptivity, and silica is particularly preferable.

Also, it is preferable that the inorganic fine particle have a specific surface area measured by the BET method of 100 m²/g or more. Although there is no upper limit for the BET specific surface area, it is preferably about 1000 m²/g or less. The BET specific surface area is more preferably about 200 to 400 m²/g.

The BET method used in this specification is one of the surface measuring methods for measuring the surface of powder by a vapor phase adsorption, and is a method for obtaining a total surface area of one gram sample, i.e., specific surface area, from absorption isotherm.

Although the average secondary particle size of the inorganic fine particle when the primary particles thereof are aggregated to form aggregated particles (secondary particles) is not particularly limited, it is preferably 0.05 to 1.0 μm, and more preferably 0.05 to 0.5 μm.

The amount of inorganic fine particle used in the ink receiving layer is preferably 20 to 90% by mass, and more preferably 30 to 80% by mass, with respect to the solid components of the ink receiving layer. Note that when the amount of the inorganic fine particle is in the above-mentioned range, there is no danger that the coating strength of the ink receiving layer is lowered, and excellent ink absorptivity, ink drying property, and high quality image may be obtained.

According to the present invention, as mentioned above, silica is preferably used as the inorganic fine particle. Silica may be mainly separated into two categories of natural silica which may be obtained by pulverizing natural silica, such as quartz, and synthetic silica which may be manufactured by synthesis. The synthetic silica may be further separated into vapor phase silica and wet process silica.

According to the present invention, wet process fine silica which will be described later is preferably used among the vapor phase silica and the wet process silica from the viewpoint of obtaining high ink absorptivity, transparency, and glossiness.

The vapor phase silica is also called dry process silica in relation to the wet process silica, and may be produced by flame hydrolysis. More specifically, it is produced by heating silicon tetrachloride with hydrogen and oxygen. Silane, such as methyltrichlorosilane and trichlorosilane, may be used alone instead of silicon tetrachloride or in mixture with silicon tetrachloride. The vapor phase silica is commercially available as powder of very low bulk density.

When an aqueous dispersion of vapor phase silica is dried, it becomes porous silica gel and the volume of fine pores thereof measured by the BET method is generally 1.2 to 1.6 ml/g. This volume of fine pores is convenient for absorbing ink. However, cracks are often generated when dried, and it is not easy to produce an ink receiving layer with no cracks.

As wet process silica, one which is produced by sedimentation method and one which is produced by gel method are known.

The sedimentation method silica is produced by adding mineral acid to a silicic acid alkali aqueous solution stepwise and filtering the precipitated silica as disclosed in Japanese Laid-open Patent Application No. Sho 55-116613, for example.

The gel method silica is produced by mixing mineral acid with a silicic acid alkali aqueous solution to form gel and then washing and pulverizing it.

In the sedimentation method silica and the gel method silica, primary particles are bonded to each other to form secondary particles. Accordingly, a number of voids are formed between the primary particles and the secondary particles, and hence a large amount of ink may be absorbed. Also, since its property of scattering light is small, a high print density may be obtained.

Moreover, as an example of wet process silica which is produced by a somewhat special method, there is fine silica which is produced by condensing active silica (hereinafter referred to as wet process fine silica) as disclosed in U.S. Pat. No. 2,574,902, Japanese Laid-open Patent Application No. 2001-354408, and Japanese Laid-open Patent Application No. 2002-145609. Here, the term “active silica” means a silicic acid aqueous solution of pH 4 or less which may be obtained by, for example, subjecting an alkali metal silicate aqueous solution to an ion exchanging process using a hydrogen type cation exchange resin.

The wet process fine silica disclosed in U.S. Pat. No. 2,574,902 is produced by preparing an active silica aqueous solution by treating a diluted aqueous solution of sodium silicate with a cation exchange resin to remove sodium ions, then adding alkali to a part of the active silica aqueous solution so as to be polymerized in a stable manner to form a dispersion (a seed solution) in which seed particles of silica are dispersed, and gradually adding the rest of the active silica aqueous solution (a feed solution) thereto while maintaining an alkali condition to polymerize silicic acid so as to grow the particle of colloidal silica.

The fine silica has a diameter of 3 nm to a few hundred nanometers, and is characterized by not forming secondary aggregations and having an extremely narrow particle size distribution. It is generally called a colloidal silica, and a product of 7 nm to 10 nm is commercially available as an aqueous dispersion. When this is used for an ink receiving layer, one which has excellent glossiness and transparency can be obtained.

The wet process fine silica disclosed in Japanese Laid-open Patent Application No. 2001-354408, on the other hand, is silica fine particle obtained by “a method of producing a silica fine particle dispersion in which silica fine particles having a BET specific surface area of 100 m²/g to 400 m²/g, an average secondary particle size of 20 nm to 300 nm, and a pore volume of 0.5 ml/g to 2.0 ml/g is dispersed in a colloidal manner, characterized by adding alkali to a seed solution in which silica fine particles having a BET specific surface area of 300 m²/g to 1000 m²/g, and a pore volume of 0.4 ml/g to 2.0 ml/g are dispersed in a colloidal manner, and then adding little by little a small amount of a feed solution including at least one selected from an active silica aqueous solution and alkoxy silane so as to grow silica fine particle” or by “a method of producing silica fine particle dispersion in which silica fine particle having a BET specific surface area of 100 m²/g to 400 m²/g, an average secondary particle size of 20 nm to 300 nm, and a pore volume of 0.5 ml/g to 2.0 ml/g is dispersed in a colloidal manner, characterized by adding little by little a small amount of a mixture of alkali and a feed solution including at least one selected from an active silica aqueous solution and alkoxy silane or adding little by little a small amount of the feed solution and an alkali at the same time to a seed solution in which silica fine particle having a BET specific surface area of 300 m²/g to 1000 m²/g, and a pore volume of 0.4 ml/g to 2.0 ml/g is dispersed in a colloidal manner so as to grow silica fine particle”.

Also, the wet process fine silica disclosed in Japanese Laid-open Patent Application No. 2001-354408 and in Japanese Laid-open Patent Application No. 2002-145609 is a silica obtained by a method of producing silica fine particle dispersion in which suspension including aggregate of silica fine particle is formed by heating an aqueous solution including at least one selected from active silica and alkoxy silane, and after silica fine particle in the suspension is grown by adding little by little a small amount of at least one of an aqueous solution including an active silica and alkoxy silane to the suspension in the presence of alkali, the suspension is subjected to wet grinding.

The wet process fine silica disclosed in Japanese Laid-open Patent Application No. 2001-354408 and Japanese Laid-open Patent Application No. 2002-145609 is a silica which possesses advantages of sedimentation process silica and gel process silica together with advantages of colloidal silica. This silica is most preferably used in the present invention since it is of secondary particle formed by bonding primary particles of silica (for example, the above-mentioned colloidal silica) and it is easy to adjust the size of the secondary particle to be the wavelength of light or less so that an ink receiving layer having excellent ink absorption amount and glossiness may be readily produced. Hereinafter, the wet process fine silica is referred to as secondary fine silica.

Among these, the secondary fine silica which is produced by a condensation method disclosed in Japanese Laid-open Patent Application No. 2001-354408 is preferably used in the present invention since secondary fine silica having the above-mentioned average secondary particle size (20 nm to 300 nm) and the pore volume (0.5 ml/g to 2.0 ml/g) may be directly produced without depending on mechanical means and the particles size distribution thereof is narrow so that excellent transparency, glossiness, etc., of ink receiving layer may be obtained.

In the condensation method disclosed in Japanese Laid-open Patent Application No. 2001-354408, a silicic acid aqueous solution of pH 4 or less obtained by subjecting an alkali metal silicate aqueous solution to an ion exchanging process using hydrogen type cation exchange resin (active silica aqueous solution), for example, is preferably used as an active silica.

The concentration of the active silica aqueous solution, in terms of SiO₂ concentration, is preferably 1 to 6% by mass, more preferably 2 to 5% by mass, and pH thereof is preferably 2 to 4.

The alkali metal silicate may be one which is commercially available, and it is preferable to use liquid glass in a molar ratio of about 2 to 4 in terms of SiO₂/M₂O (where M indicates an alkali metal).

As a method for condensing active silica, it is preferable to grow a primary particle of a seed particle by adding the above-mentioned active silica aqueous solution to hot water or by heating the active silica aqueous solution, adding alkali before precipitation is caused in the dispersion or the dispersion is gelled so as to stabilize the seed particle, and then adding the active silica aqueous solution preferably at a rate of, converted to SiO₂, 0.001 to 0.2 mol/min with respect to 1 mol of SiO₂ contained in the seed particle while maintaining the stable state.

Also, it is preferable that the wet process fine silica have a BET specific surface area of 100 to 400 m²/g and a pore volume of 0.5 to 2.0 ml/g. The fine silica having these characteristics are excellent in preventing cracks from being generated on ink receiving layer, and in balance of ink absorptivity and glossiness.

Moreover, a silica-cationic compound aggregated fine particle having an average particle size of 0.7 μm or less, which is obtained by mixing and aggregating amorphous silica and a cationic compound and pulverizing a resulting silica-cationic compound aggregated particle, is preferably used in an outer ink receiving layer.

By using the silica-cationic compound aggregated fine particle, it becomes possible to make the ink receiving layer a porous layer having excellent transparency, ink absorptivity, coloring of ink, weatherability, and so forth.

The silica-cationic compound aggregated fine particle is a silica colloid particle solution including secondary particles which are substantially formed by aggregating primary particles. For the case of silica sol in which primary particles are monodispersed (for example, generally commercially available colloidal silica), a porous layer obtained by being coated on a substrate becomes relatively dense, and hence its transparency is readily deteriorated and a large amount thereof must be coated in order to obtain sufficient ink absorption property. However, if a large amount of the silica sol is coated, cracks are readily generated on the coating and a coating process tends to become complicated. Primary particles may be partially included in a silica colloide particle solution.

According to the present invention, if the silica-cationic compound aggregated particle is included in the ink receiving layer together with binder (polyvinyl alcohol is particularly preferable), transparency is obtained for printed portions, and glossiness equivalent to photographic quality may be obtained. Also, since the entire ink receiving layer is transparent, it may be used as an OHP sheet and so forth.

As mentioned above, the silica-cationic compound aggregated fine particle having an average particle size of 0.7 μm or less is obtained by mixing and aggregating an amorphous silica and a cationic compound and pulverizing the resulting silica-cationic compound aggregated particle.

The silica-cationic compound aggregated fine particle means a state of fine particles having an average particle size of 0.7 μm or less and a maximum particles size of about 1000 nm or less are uniformly dispersed.

The silica-cationic compound aggregated fine particle may be obtained by applying a strong force to a mixture of silica and a cationic compound by a mechanical means. That is, the fine particle may be obtained by a breaking down method (a method for fractionating a bulk material). The silica-cationic compound aggregated fine particle may be in the form of a slurry. The mechanical means may be an ultrasonic, a high-speed mill, a roller mill, a vessel driving medium mill, a medium agitation mill, a jet mill, a sand grinder, and so forth.

All of the average particle sizes used in the present invention are particle sizes measured by electron microscopy (SEM and TEM). That is, electron micrographs having a magnification of 10,000 to 400,000 times are taken and Martin's diameter of particles within 5 cm² are measured and averaged (refer to “Fine Particle Handbook”, Asakura Shoten, p. 52 (1991), etc.)

The average particle size of the silica-cationic compound aggregated fine particle (substantially a secondary particle) is adjusted to be 0.7 μm or less, preferably 10 to 300 nm, and more preferably 20 to 200 nm. If the silica-cationic compound aggregated fine particle having an average particle size of more than 0.7 μm is used, there is a danger that the transparency and print density thereof is significantly reduced and that ink jet recording sheet having high transparency after printing cannot be obtained. On the other hand, if silica colloid particles having an extremely small average particle size are used, there is a danger that a sufficient ink absorption rate cannot be obtained.

It is preferable that the amorphous silica which forms the silica-cationic compound aggregated fine particle have an average primary particle size of 3 nm to 40 nm. If the average primary particle size is less than 3 nm, voids present between the primary particles become significantly small. On the other hand, if the average primary particle size exceeds 40 nm, the size of aggregated secondary particles becomes large and there is a danger that the transparency of ink receiving layer is reduced.

As a cationic compound used for the silica-cationic compound aggregated fine particle, various known cationic compounds which are generally used for ink jet paper may be used. Examples of the cationic compounds include a primary amine type cationic polymer having a primary amine salt as a structural unit, such as monoallyl amine salt, vinyl amine salt, N-vinyl acrylamidine salt, dicyandiamide.formalin polycondensation products, and dicyandiamide.polyethyleneamine polycondensation products; a secondary amine type cationic polymer having a secondary amine salt as a structural unit, such as diallylamine salt and ethyleneimine salt; a tertiary amine type cationic polymer having a tertiary amine salt as a structural unit, such as diallylmethylamine salt; a quaternary ammonium type cationic polymer having a quaternary ammonim salt as a structural unit, such as diallyldimethylammoniumchloride, (meth)acryloyloxyethyltrimethylammoniumchloride, (meth)acrylamidepropyltrimethyl ammoniumchloride, dimethylamine.epichlorohydrin polycondensation product, aluminum compounds, such as basic aluminum polychloride, and basic aluminum polyfatty acids; and zirconyl compounds, such as zirconyl chloride, basic zirconyl chloride and zirconylium fatty acid. Also, it is possible to use two or more of these cationic compounds in combination. Note that the amount of the cationic compound added is adjusted to be 1 to 30 parts by mass, more preferably 5 to 20 parts by mass, with respect to 100 parts by mass of amorphous silica.

According to the present invention, when the silica-cationic compound aggregated fine particle is used as an inorganic fine particle, polyvinyl alcohol (PVA) is most effective as a binder from the viewpoints of proper dispersion and rheological stability of coating. In particular, PVA having a polymerization degree of 2,000 or more is preferably used in order to obtain suitable dispersion and ink absorption. The polymerization degree of PVA is more preferably between 2,000 and 5,000. Also, PVA having 95% or more of saponification degree is effective for obtaining an appropriate water resistance.

Although the ratio of solid content mass of the silica-cationic compound aggregated fine particle to the binder is not particularly limited, it is adjusted to be within the range of 10/1 to 10/10, more preferably within the range of 10/2 to 10/6. If the amount of binder added is too large, pore size between particles becomes small and a sufficient ink absorption rate may not be obtained. On the other hand, if the amount of binder added is too small, cracks may be generated on the coating layer and may become practically inapplicable.

<Cationic Polymer>

As explained above, the cationic polymer used in the present invention is a polymer (hereinafter referred to as polymer (A)) including at least one structural unit (a1) expressed by the following general formula (1) or (2): 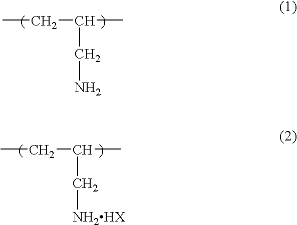
wherein X represents an acid residue; and at least one structural unit (a2) expressed by a following general formula (3): 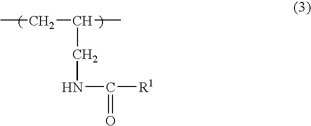
wherein R¹ represents a C₁₋₈ alkyl group, C₁₋₁₈ alkoxy group, C₆₋₁₂ aryl group, or benzyl group.

According to the present invention, an ink receiving layer having an excellent rheological stability of coating may be obtained by including the polymer (A) in the ink receiving layer together with the above-mentioned inorganic fine particle having an average primary particle size of 30 nm or less.

Also, the ink receiving layer obtained by coating this coating solution has almost no problems of cracks, and is excellent in glossiness, ink absorptivity and ink drying property as well as the quality of printed image and long-term preservability thereof.

In the general formula (3), R¹ represents a C₁₋₁₈ alkyl group, C₁₋₁₈ alkoxy group, C₆₋₁₂ aryl group, or benzyl group.

Examples of the C₁₋₁₈ alkyl group include methyl, ethyl, n-propyl, isopropyl, butyl, pentyl, hexyl, octyl, nonyl, decyl, dodecyl, and octadecyl.

Examples of the C₁₋₁₈ alkoxy group include methoxy, ethoxy, propoxy, butoxy, pentaoxy, hexaoxy, octyloxy, nonyloxy, decyloxy, dodecyloxy, and octadecyloxy.

Examples of the C₆₋₁₂ aryl group include phenyl group, tolyl group, methoxyphenyl group, and naphthyl group.

Among these, the methoxy group is preferable since it is easy to prepare and has, inter alia, an excellent heat and humidity resistance.

The acid indicated by HX in the general formula (2) may be inorganic acids or organic acids, and examples of the inorganic acids include hydrochloric acid, sulfuric acid, nitric acid, phosphoric acid, pyrophosphoric acid and metaphosphatic acid, and examples of the organic acids include formic acid, acetic acid, propionic acid, methanesulfonic acid, and p-toluenesulfonic acid. These may be used singularly or in a mixture of two or more. Among these acids, hydrochloric acid and sulfuric acid are effective for print image preservability, and hence are preferable.

The molar ratio of the structural unit (a1) and (a2) in the polymer (A) is preferably 0.1:1 to 50:1, and more preferably 0.5:1 to 20:1. By adjusting the molar ratio to be within the above range, a printed image of high quality having excellent long-term preservability and rheological stability of coating may be obtained.

The above-mentioned polymer (A) may further include at least one structural unit (a3) expressed by the following general formulae (4), (5), (6) or (7): 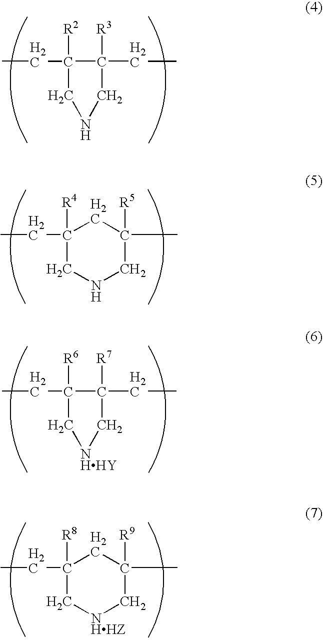
wherein R² to R⁹ each independently represents a hydrogen atom or an alkyl group having a number of carbon atoms of 1 to 4, and Y and Z independently represents an acid residue.

The acid indicated by HY and HZ in the general formulae (6) and (7) may be inorganic acids or organic acids, and examples of the inorganic acids include hydrochloric acid, sulfuric acid, nitric acid, phosphoric acid, pyrophosphoric acid and metaphosphatic acid, and examples of the organic acids include formic acid, acetic acid, propionic acid, methanesulfonic acid, and p-toluenesulfonic acid. These may be used singularly or in a mixture of two or more. Among these acids, hydrochloric acid and sulfuric acid are effective for print image preservability, and hence are preferable.

In the polymer (A), examples of the structural unit (a3) include secondary amines having two vinyl alkyl groups, such as diallyl amine, di(2-methylallyl)amine and di(2-ethylally)amine, or structural units including acid salts thereof as a structural unit. In particular, cation polymers in which the structural unit (a3) is diallyl amine or which includes the acid salt thereof as a monomer of the structural unit are preferable because high quality image having excellent preservability, such as light resistance and ozone resistance, may be obtained.

In the polymer (A), the molar ratio of the total of the structural unit (a1) and (a2) to the structural unit (a3) is preferably 0.1:1 to 10:1, and more preferably 0.5:1 to 5:1. By adjusting the molar ratio to be within the above range, a printed image of high quality having excellent long-term preservability and rheological stability of coating may be obtained.

The molecular weight of the polymer (A) used in the present invention is preferably within the range between 1,000 and 500,000, and more preferably 10,000 and 200,000. If the molecular weight thereof is within this range, excellent rheological stability of coating, image quality, preservability, such as light resistance and heat and humidity resistance, and ink absorbing properties may be obtained, and the problems of generation of cracks may be eliminated.

The amount of the cation polymer contained in the ink receiving layer is preferably 0.01 to 10 g/m², and more preferably 0.05 to 5 g/m². If the amount of the cation polymer is within this range, image quality, preservability and ink absorptivity may be improved.

Although methods for including the polymer (A) used in the present invention into an ink receiving layer is not particularly limited, examples thereof include a method in which the polymer is added in an ink receiving layer coating solution and then coated on a supporting medium, a method in which an aqueous solution thereof is coated prior to coating the ink receiving layer, and a method in which an aqueous solution is applied after the ink receiving layer is coated.

When the polymer (A) is added to an ink receiving layer coating solution, it is possible to form the above-mentioned silica-cationic compound aggregated fine particles together with silica and to use it.

Also, for the case where the ink receiving layer is made of a plurality of layers, it is preferable that after at least one layer of the ink receiving layers (an inside ink receiving layer) is formed, an ink receiving layer solution is applied thereon so that at least one other ink receiving layer (an outside ink receiving layer) is formed. The method is more effective for improving the high temperature and humidity resistance of an image, and the effect of inhibiting generation of cracks is also high.

It is preferable to add a cross-linking agent to an aqueous solution including the polymer (A) from the viewpoint of inhibiting the generation of cracks.

Specific examples of the cross-linking agent include boron compounds, such as boric acid, borax and borate, glyoxzal, melamine.formaldehyde, gultaraldehyde, methylol urea, polyisocyanate compounds, epoxy compounds, aziridine compounds, carbodiimido compounds, dihidrazide compounds, aluminum compounds, zirconyl compounds, and so forth. Among these, boron compounds are preferable, and borax is particularly preferable.

By adding a mixed solution of borax and the polymer (A), it becomes possible to particularly improve the high temperature and humidity resistance, and the crack generation inhibitory effect may also be improved.

Also, it is preferable to adjust pH of the mixed solution within the range of 7.0 to 10.0, more preferably 7.5 to 9.0 using alkali, such as sodium hydroxide, since it is effective for preventing the generation of cracks.

In this case, the amount of the cross-linking agent applied is preferably 0.01 to 1.0 g/m², more preferably 0.05 to 0.5 g/m². If the amount is less than 0.01 g/m², the effect of preventing the generation of cracks is reduced, and if it exceeds 1.0 g/m², on the other hand, there is a danger that bending or breaking of the ink receiving layer may be caused due to strong contraction generated during drying and that the ink absorption property thereof may be lowered.

Also, the mass ratio of the cross-linking agent to the polymer (A) is preferably within the range between 1:1 to 1:20, and more preferably 1:1 to 1:10. If the mass ratio is within this range, ink jet recording sheets which are excellent in time-lapse feathering resistance and ink absorption property may be obtained.

According to the present invention, it is possible to use various known cationic polymers other than the polymer (A) if it does not interfere with the effects of the present invention.

<Hindered Amine Photo Stabilizer>

According to the present invention, the light resistant fastness may be further improved by adding a specific hindered amine type photo stabilizer in the ink receiving layer.

The specific hindered amine photo stabilizer used in the present invention is a polymer (B) which includes at least one structural unit (b1) expressed by the following general formula (8): 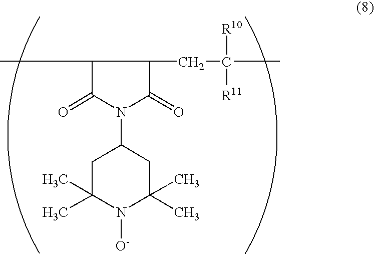
wherein R¹⁰ and R¹¹ each independently represents a hydrogen atom or a C₁₋₈ alkyl group; and at least one structural unit (b2) expressed by the following general formula (9) and/or (10): 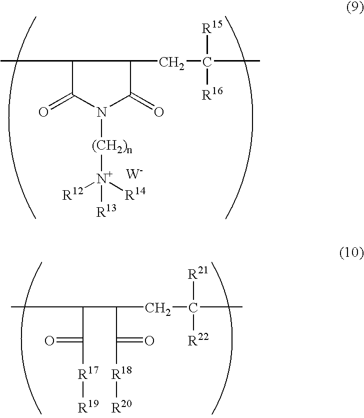
wherein R¹⁵, R¹⁶, R²¹, and R²² each independently represents a hydrogen atom or a C₁₋₈ alkyl group, R¹² to R¹⁴ each independently represents a C₁₋₈ alkyl group, W represents an acid residue, and n represents an integer of 1 to 6. Also, R¹⁷ and R¹⁸ each independently represents an oxygen atom or a N—R²³ where R²³ is a hydrogen atom or a C₁₋₈ alkyl group. Moreover, R¹⁹ and R²⁰ each independently represents a hydrogen atom or a C₁₋₈ alkyl group.

As described above, R¹⁰ and R¹¹ each independently represents a hydrogen atom or a C₁₋₈ alkyl group in the general formula (8). Specific examples of the C₁₋₈ alkyl group include methyl, ethyl, n-propyl, iso-propyl, butyl, pentyl, hexyl, and octyl group.

As described above, R¹⁵, R¹⁶, R²¹ and R²² each independently represents a hydrogen atom or a C₁₋₈ alkyl group in the general formula (9) and (10). Specific examples of the C₁₋₈ alkyl group include methyl, ethyl, n-propyl, iso-propyl, butyl, pentyl, hexyl, and octyl group.

As described above, R¹² to R¹⁴ each independently represents a C₁₋₈ alkyl group in the general formula (9). Specific examples of the C₁₋₈ alkyl group include methyl, ethyl, n-propyl, iso-propyl, butyl, pentyl, hexyl, and octyl group.

As described above, W in the general formula (9) indicates an acid residue. Specific examples of the acid residue include inorganic acids, such as hydrochloric acid, sulfuric acid, nitric acid, phosphoric acid, pyrophosphoric acid, and metaphosphatic acid, and organic acids, such as formic acid, acetic acid, propionic acid, methanesulfonic acid, and p-toluenesulfonic acid. These may be used singularly or in a mixture of two or more. Among these acids, hydrochloric acid and sulfuric acid are effective for print image preservability, and hence are preferable.

As described above, R¹⁷ and R¹⁸ each independently represents an oxygen atom or a N—R²³ in the general formula (10) where R²³ is a hydrogen atom or a C₁₋₈ alkyl group. Moreover, R¹⁹ and R²⁰ each independently represents a hydrogen atom or a C₁₋₈ alkyl group. Examples of such combination include CO—OH, CO—ONa, CO—NH, NH—H, NH—CH₃, and so forth.

Among the above-mentioned hindered amine type photo stabilizers, the polymer (B) in which the structural unit (b2) is expressed by the following general formula (11) is preferable since it is easy to produce and has excellent rheological stability of coating. 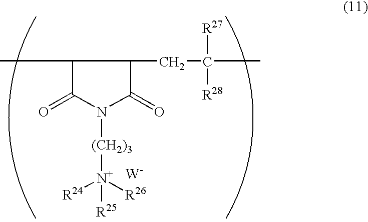
wherein R²⁷ and R²⁸ each independently represents a hydrogen atom or a methyl group. Also, R²⁴ to R²⁶ each independently represents a C₁₋₃ alkyl group, and W represents an acid residue.

It is preferable that W in the general formula (11) be a halogen atom, in particular, Br or Cl from the viewpoint of water solubility, rheological stability of coating, image quality, light resistance fastness and so forth.

Examples of particularly preferable hindered amine type photo stabilizer include the following: 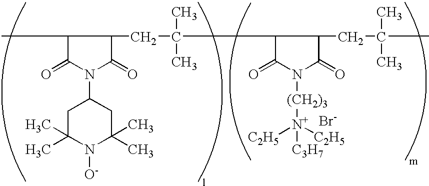
wherein 1 and m each represents an integer.

It is preferable that the molar ratio of the structural unit (b1) and the structural unit (b2) in the polymer (B) be within the range of 10:1 to 1:2. By adjusting the amount of the structural unit (b1) to be within this range, it becomes possible to exert effects as a photo stabilizer. By adjusting the amount of the structural unit (b2) to be within this range, on the other hand, a sufficient hydrophilic property may be obtained and image quality of the ink jet recording may be improved.

The molecular weight of the polymer (B) used in the present invention is preferably within the range between 1,000 and 500,000, and more preferably 5,000 and 100,000. If the molecular weight thereof is within this range, excellent rheological stability of coating, image quality, preservability, such as light resistance and heat and humidity resistance, and ink absorbing properties may be obtained, and the problems of generation of cracks may be eliminated.

The amount of the hindered amine type photo stabilizer contained in the ink receiving layer is preferably 0.01 to 10 g/m², and more preferably 0.05 to 5 g/m². If the amount of the cation polymer is within this range, image quality, preservability and ink absorptivity may be improved.

Although methods for including the polymer (B) used in the present invention into an ink receiving layer are not particularly limited, examples thereof include a method in which the polymer is added in an ink receiving layer coating solution and then coated on a supporting medium, a method in which an aqueous solution thereof is coated prior to coating the ink receiving layer, and a method in which an aqueous solution is applied after the ink receiving layer is coated.

When the polymer (B) is added to an ink receiving layer coating solution, it is possible to form the above-mentioned silica-cationic compound aggregated fine particles together with silica and use it.

It is preferable to add a cross-linking agent to an aqueous solution including the polymer (B) from the viewpoint of inhibiting the generation of cracks.

According to the present invention, it is possible to add various other fastness improving agents as long as it does not affect the effects of the invention.

<Binder>

Examples of the binder which may be contained in the ink receiving layer include starch derivatives, such as oxidized starch and etherified starch; cellulose derivatives, such as carboxymethyl cellulose and hydroxyethyl cellulose; proteins, such as casein, gelatin and soy bean proteins; polyvinyl alcohols, such as completely (or partially) saponificated polyvinyl alcohol, silicon denatured polyvinyl alcohol, acetoacetyl group denatured polyvinyl alcohol and cation denatured polyvinyl alcohol; aqueous adhesives, such as salt of styrene-maleic anhydride copolymer, styrene-butadiene latex, acryl latex, polyester-polyurethane latex, and vinyl acetate latex; and organic solvent soluble resin, such as polymethacrylate, polyurethane resin, unsaturated polyester resin, vinyl chloride-vinyl acetate copolymer, polyvinyl butyral, and alkyd resin. These binders may be used alone or in a mixture of two or more.

Among the above binders, polyvinyl alcohols are preferable in terms of their high transparency and water resistance, non-ionic property which makes them capable of mixing with various material, and relatively low swelling at room temperature. Also, polyvinyl alcohols have advantages in that they do not swell and clog pores when ink is initially permeated.

Among polyvinyl alcohols, completely (or partially) saponificated polyvinyl alcohol, cation denatured polyvinyl alcohol, and silicon denatured polyvinyl alcohol are particularly suitable.

As the completely (or partially) saponificated polyvinyl alcohol, a partially saponificated polyvinyl alcohol having a saponification degree of 80% or more, particularly 95% or more, or a completely saponificated polyvinyl alcohol is preferable, and its average polymerization degree is preferably in the range between 200 and 5,000, and more preferably between 500 and 5,000.

The reason why a completely (or partially) saponificated polyvinyl alcohol having a saponification degree of 80% or more is preferable is because such polyvinyl alcohol possesses a superior water resistance. Also, the reason why the average polymerization degree of 200 to 5,000 is preferable is because an excellent water resistance and viscosity of easy-handling may be obtained when one having such polymerization degree is used.

Also, as a cation denatured polyvinyl alcohol, one having a primary, secondary, or tertiary amino group or a quaternary ammonium salt group in a main chain or a branched chain of polyvinyl alcohol is preferable.

The amount of binder is preferably 1 to 100 parts by mass, more preferably 5 to 50 parts by mass, with respect to 100 parts by mass of inorganic fine particle.

<Other Components>

According to the present invention, it is preferable to use the above-mentioned binder together with the above-mentioned cross-linking agent. In this manner, it becomes possible to reduce the generation of cracks and to improve the ink absorptivity, glossiness, image quality, and so forth.

The cross-linking agent may be included in a coating solution for forming the ink receiving layer, or a solution including the cross-linking agent may be coated before or after coating an ink receiving layer.

The amount of cross-linking agent coated is preferably within the range of 0.01 to 1.0 g/m², and more preferably 0.05 to 0.5 g/m². If the amount is less than 0.01 g/m², effect of preventing the generation of cracks is reduced, and if the amount exceeds 1.0 g/m², on the other hand, there is a danger that bending or breaking of the ink receiving layer may be caused due to strong contraction generated during drying and that the ink absorption property thereof may be lowered.

According to the present invention, in order to improve the high temperature and humidity resistance, it is possible to include aluminum compounds, such as basic aluminum chloride, basic aluminum sulfate, and basic aluminum fatty acids; and zirconyl compounds, such as zirconyl chloride, basic zirconyl chloride, zirconyl nitrate, and zirconyl fatty acids. Specific examples of the fatty acids in the basic aluminum fatty acids, zirconyl fatty acids include, formic acid, acetic acid, propionic acid, butanic acid, glycolic acid, 3-hydorxy propionic acid, 4-hydroxy butanic acid, glycine, β-alanine, 4-amino butanic acid, oxalic acid, malonic acid, succinic acid, glutaric acid, azipic acid and so forth in the ink receiving layer. Among them, acetic acid is particularly preferable.

Also, according to the present invention, it is possible to use various known compounds which are used to improve preservability, such as light resistance and gas resistance. Examples of such compounds include phenol type antioxidants, additional hindered amine photo stabilizers, benzotriazole ultraviolet ray absorbents, sulfur compounds, water soluble metallic salt and so forth.

Moreover, according to the present invention, it is possible to use oxoacid salt of phosphorus as a coating stabilizer. Specific examples thereof include alkali metal salt, alkaline earth metal salt, ammonium salt, zincate, etc., of phorsphoric acid, phosphorous acid, hypophosphorous acid, metaphosphoric acid, metaphosphorous acid, pyrophosphoric acid, pyrophosphorous acid, polyphosphoric acid, and so forth.

Among these, hypophosphite is preferable from the viewpoint of its excellent effect of rheological stability of coating.

Specific examples of the hypophosphite include sodium hypophosphite, potassium hypophosphite, calcium hypophosphite, magnesium hypophosphite, barium hypophosphite, ammonium hypophosphite, zinc hypophosphite and so forth. Among these, sodium hypophosphite is particularly preferable due to its highest effect of rheological stability of coating.

It is also possible to add various known dispersing agents, thickeners, flowability modifiers, antifoamers, foam inhibitors, release agents, foaming agents, penetrants, colorants, pigments, fluorescent brighteners, antiseptics, antimordant and so forth in the ink receiving layer.

The ink receiving layer may be formed by applying a solution for ink receiving layer including the above-mentioned various components onto at least one surface of a supporting medium, and drying it.

The amount of the solution for the ink receiving layer applied is preferably in the range of 2 to 50 g/m², and more preferably in the range of 3 to 30 g/m², in dry mass for the case where the ink receiving layer is not formed by the above-mentioned inside ink receiving layer and outside ink receiving layer. If the applied amount is within the above-mentioned range, excellent quality of recorded image and coating strength may be obtained.

The solution for the ink receiving layer may be coated using a bar coater, a blade coater, an air knife coater, a gravure coater, a die coater, a curtain coater, and so forth.

Also, for the case where the ink receiving layer is formed by, after forming at least one inside ink receiving layer, applying an aqueous coating solution including the polymer (A) onto the inside ink receiving layer, and applying a solution for ink receiving layer thereon to form an outside ink receiving layer as explained above, the amount of the inside ink receiving layer applied is preferably 2 to 50 g/m², and more preferably 5 to 30 g/m², in dry mass. Also, the amount of the outside ink receiving layer applied is preferably 2 to 50 g/m², and more preferably 5 to 30 g/m², in dry mass.

According to the present invention, for the case where the ink receiving layer is formed by a plurality of layers of inside ink receiving layer and outside ink receiving layer as explained above, the polymer (A) may be included in at least one ink receiving layer. However, it is preferable that the polymer (A) be included in an outside ink receiving layer which is located at or close to the top of the plurality of layers. In this manner, it becomes possible to improve the print density and preservability.

Also, an ink jet recording sheet having a higher degree of surface glossiness may be obtained by, after applying a solution for ink receiving layer, subjecting a coated layer to a cast process while the layer is in a wet state so the ink receiving layer is directly cast.

Methods for the cast process include wet process, gelling process and rewetting process. In the wet process, a coated layer is pressure welded to a heated specular surface drum while the coated layer is in a wet state to obtain a strong calender finish. In the gelling process, a coated layer is contacted a gelling agent vessel while the coated layer is in a wet state, and the coated layer turned into a gel state is press welded to a heated drum surface to obtain a strong calender finish. In the rewetting process, after a coated layer in a wet state is once dried, the dried coated layer is contacted with a wetting solution again, and then the layer is press welded to a heated drum surface to obtain a strong calender finish.

When the ink receiving layer is subjected to a cast process, it is preferable that a parting agent be included in the ink receiving surface. As a parting agent, various parting agents which are generally known in the field of coated paper may be utilized.

Also, after forming the ink receiving layer, in order to impart glossiness, etc., it is possible to make smooth the surface thereof by passing between roll nips while applying pressure to it using, for example, a super calender, gloss calender, soft calender, and so forth.

<<Other Structures>>

<Glossy Layer>

According to the present invention, it is possible to provide a glossy layer, which has been subjected to a cast process, on the above-mentioned ink receiving layer. In this manner, an ink jet recording sheet having higher surface glossiness may be obtained.

The glossy layer may include pigments and/or resins.

It is preferable to make the glossy layer porous or liquid permeable within a range not interfering with the glossiness thereof so that the ink may be passed through or be absorbed by the glossy layer quickly.

The pigment used in the glossy layer may be the same as those of inorganic fine particles used in the ink receiving layer. However, from the viewpoints of glossiness, transparency, and ink absorption, colloidal silica, amorphous silica, alumina, alminosilicate, zeolite, synthesized smectite, etc., are preferable.

The alumina which may be used in the present invention is generally an aluminum oxide having crystalline property. In general, examples of such aluminum oxide include one having χ, κ, γ, d, θ, η, ρ, pseudo-γ, and a crystal.

According to the present invention, alumina is preferable from the viewpoints of glossiness, ink absorptivity, and pigment ink, and alumina having γ, d or θ crystal is preferably used. The vapor phase alumina (fumed alumina) whose particle size distribution is sharp and has an excellent film forming property is most preferable.

The vapor phase alumina is alumina which is formed by hydrolysis of gaseous aluminum trichloride at high temperature, and eventually forms alumina particles of high purity.

The primary particle size of the particles is on the order of nanometers, and has a very narrow particle size distribution. Such vapor phase alumina has a cationic surface charge.

Use of vapor phase alumina in an ink jet coating is disclosed, for example, in U.S. Pat. No. 5,171,626. Also, although the alumina hydrate used in the present invention is not particularly limited, boehmite or pseudoboehmite is preferably used from the viewpoints of ink absorptivity and film forming property.

Examples of methods for preparing alumina hydrate include, for example, a method in which aluminum isopropoxide is hydrolyzed using water (B. E. Yoldas, Amer. Ceram. Soc. Bull., 54, 289 (1975) and a method in which aluminum alkoxide is hydrolyzed (Japanese Laid-Open Patent Application No. Hei 06-064918).

It is preferable that the amount of the pigments contained in the glossy layer be in the range of 10 to 90% by mass.

The average particle size of the pigment (the size of aggregated particle for aggregated particles) is preferably within the range of 0.001 to 1 μm, and more preferably 0.005 to 0.5 μm. If the particle size is within this range, excellent ink absorptivity, glossiness, and print density may be obtained.

Examples of resins used in the glossy layer include water soluble binder (for example, polyvinyl alcohols, such as polyvinyl alcohol, cation denatured polyvinyl alcohol and silyl denatured polyvinyl alcohol; casein, soy bean protein synthesized proteins, starch, and cellulose derivatives, such as carboxy methyl cellulose and methyl cellulose); conjugated diene polymer latex, such as styrene-butadiene copolymer and methylmethacrylate-butadiene copolymer; vinyl copolymer latex, such as styrene-vinyl acetate copolymer; various resins (adhesives) generally known and used in the field of coated paper, such as an aqueous dispersion resin, aqueous acryl resin, aqueous polyurethane resin, and aqueous polyester resin. These may be used alone or in a mixture.

Note that when a glossy layer is formed mainly by a resin, it is preferable that the resin include, as a main component, polymer or copolymer (hereinafter abbreviated as polymer) formed by polymerizing monomer having ethylenically unsaturated bonding (hereinafter referred to as an ethylenic monomer). Also, it is possible to use substituted derivatives of these polymers.

Moreover, it is possible to polymerize the above-mentioned ethylenic polymer in the presence of colloidal silica to make it a complex bonded by Si—O—R (where R is a polymer component) bonding, or to introduce a functional group, such as SiOH group, which reacts with colloidal silica, into the above-mentioned polymer so that the polymer may be reacted with colloidal silica to form a complex. These complexes may also be suitably used in the present invention. When such a complex is used, the resulting ink receiving layer tends to have excellent glossiness and ink absorption.

It is also preferable that a parting agent be included in the glossy layer. Examples of the parting agents include various parting agents which are known and generally used in the field of coated paper.

Moreover, it is possible to add to the glossy layer a cationic compound to enhance the print concentration and water resistance, and various adjuvants in order to improve the light resistance and gas resistance.

The glossy layer is formed by applying a solution for glossy layer including the above-mentioned various components onto an ink receiving layer to form a coated layer, subjecting the coated layer to a cast process, and drying it.

The amount of a solution for glossy layer applied is preferably 0.1 to 30 g/m², more preferably 0.2 to 10 g/m², in dry mass. If the applied amount is within this range, glossiness, ink drying property, and recording density become excellent.

The coating and cast process of the solution for glossy layer may be carried out using the same methods as described for the above-mentioned ink receiving layer.

The drying temperature for the glossy layer is also important. If the drying temperature is too high, the formation of the layer is too advanced and the porosity of the surface is reduced. As a result, the ink absorption rate decreases. If the drying temperature is too low, on the other hand, there is a tendency for the glossiness as well as productivity to be reduced. The drying temperature is preferably within the range between 50 and 150° C., and more preferably between 70 and 120° C.

Also, according to the present invention, various techniques known in the field of producing ink jet recording sheet may be utilized. Accordingly, it is possible to provide an intermediate layer between the supporting medium and the ink receiving layer, to dispose a protective layer at the back surface, i.e., the surface on which the ink receiving layer is not formed, of the supporting medium, to make the back surface thereof sticky, and so forth.

Liquid ink used for recording an image on ink jet recording sheet according to the present invention may be a recording liquid including coloring agents, liquid medium, and other arbitrary selected additives. Commercially available arbitrary liquid ink for ink jet recording may also be employed.

Examples of the coloring agents include various water soluble dye, such as direct dye, acidic dye, reactive dye, etc., and carbon black and organic pigments whose particle size is adjusted to be about 100 nm and is surface treated by a resin, surfactant, and so forth.

Also, as a liquid medium, water may be used solely or in combination with water soluble organic solvent. Examples of the water soluble organic solvent include monovalent alcohol, such as ethylalcohol and isopropyl alcohol; polyvalent alcohol, such as ethylene glycol, diethylene glycol, polyethylene glycol and glycerin; and a lower alkyl ether of polyalcohol, such as triethylene glycol monomethyl ether and triethylene glycol monoethyl ether.

Among these, a combination of pigment ink which includes 1,2-hexane diol and glycerin as an aqueous organic solvent and the total of the both is equal to 80% by mass or more, with the ink jet recording sheet of the present invention is suitable in terms of pigment ink suitability, in particular abrasion resistance.

Examples of the additives include a pH controlling agent, sequestering agent, antimordant, viscosity controlling agent, surface tension controlling agent, surfactant, rust inhibitor, and so forth.

### EXAMPLES

Hereinafter, the present invention will be explained in detail with reference to Examples. However, it is apparent that the present invention is not limited to these examples. Also, “parts” and “%” used in the examples indicate “parts by mass” and “% by mass” unless otherwise so indicated.

### Example 1

(Preparation of Coating Solution A for Ink Receiving Layer)

Vapor phase silica (100 parts, trade name: Aerosil 300, a product of Aerosil Co., average particle size of primary particle of 7 nm, BET specific surface area of 300 m²/g), 20% by mass aqueous solution of 50 mol % methoxycarbonyl denatured polyallylamine hydrochloride (40 parts, molecular weight of about 15,000) and ion exchanged water (691 parts) were mixed and dispersed using an agitation device, and the mixture was treated using a wet type nanomizer. Then, 5% by mass aqueous solution of polyvinyl alcohol (367 parts, trade name: PVA-145, a product of Kuraray Co., Ltd., saponification degree of 99%, average polymerization degree of 4,500) and a small amount of antifoaming agent, dispersing agent and water were added. As a result, a coating solution A for ink receiving layer having a solid component concentration of 8% was obtained.

(Preparation of Coating Solution B for Ink Receiving Layer)

To a 20% dispersion of wet process synthesized amorphous silica (500 parts, trade name: Sylojet 703A, a product of Grace Davison Co. Ltd.), 5% aqueous solution of polyvinyl alcohol (400 parts, trade name: PVA-145, a product of Kuraray Co., Ltd.), and a small amount of antifoaming agent, dispersing agent and water were added. As a result, a coating solution B for ink receiving layer having a solid component concentration of 15% was obtained.

(Preparation of Ink Jet Recording Sheet)

The coating solution B for ink receiving layer was applied onto a paper supporting medium in which both surfaces of 180 g/m² base paper were coated by polyethylene resin (thickness of 240 μm, and the polyethylene resin included 15% by mass of anatase titanium dioxide) using a wired bar so that the solid component contained in the coating solution B became 20 g/m², and this was dried to prepare an ink receiving layer B. Then, 0.5% borax aqueous coating solution was applied so as to be 20 g/m², and the coating solution A for ink receiving layer was applied thereon using a wired bar and dried so that the solid component contained in the coating solution A became 10 g/m² to obtain ink jet recording sheet.

### Examples 2-10

Ink jet recording sheet was prepared in the same manner as in Example 1 except that the following compounds were used instead of 50 mol % methoxycarbonyl denatured polyallylamine hydrochloride (molecular weight of about 15,000):

In Example 2: 50 mol % methoxycarbonyl denatured polyallylamine hydrochloride (molecular weight of about 60,000);

In Example 3: 30 mol % methoxycarbonyl denatured polyallylamine hydrochloride (molecular weight of about 15,000);

In Example 4: 20 mol % methoxycarbonyl denatured polyallylamine hydrochloride (molecular weight of about 15,000);

In Example 5: methane sulfonate of 50 mol % methoxycarbonyl denatured polyallylamine (molecular weight of about 15,000);

In Example 6: 50 mol % acetyl denatured polyallylamine hydrochloride (molecular weight of about 15,000);

In Example 7: 50 mol % ethoxycarbonyl denatured polyallylamine hydrochloride (molecular weight of about 15,000);

In Example 8: 50 mol % isopropoxycarbonyl denatured polyallylamine hydrochloride (molecular weight of about 15,000);

In Example 9: 50 mol % phenoxycarbonyl denatured polyallylamine hydrochloride (molecular weight of about 15,000); and

In Example 10: allylamine hydrochloride.50 mol % methoxycarbonyl denatured polyallylamine hydrochloride.diallylamine hydrochloride copolymer (molar ratio of 2:2:1, molecular weight of about 20,000).

### Examples 11-12

Ink jet recording sheet was prepared in the same manner as in Example 1 except that the following compound was further added to the coating solution A for ink receiving layer:

In Example 11: 100 parts of basic aluminum acetate aqueous solution (concentration of 5% by mass converted to Al₂O₃); and

In Example 12: 15 parts of zirconyl acetate aqueous solution (concentration of 30% by mass converted to ZrO₂)

### Example 13

(Preparation of Silica Fine Particle Dispersion)

Distilled water was added to silicate soda solution having a SiO₂ concentration of 30% by mass and SiO₂/Na₂O (molar ratio) of 3.1 (a product of Tokuyama Corporation) to prepare diluted silicate soda aqueous solution having SiO₂ concentration of 4.0% by mass, and the aqueous solution was passed through a column filled with a hydrogen cation exchange resin (“Diaion SK-1BH”, a product of Mitsubishi Chemical Corporation) to obtain an active silicate solution. Distilled water (500 g) was introduced to a 5 liter reaction vessel made of glass, which was provided with a reflux, stirrer and thermometer and heated to 100° C. While maintaining the temperature at 100° C., 450 g of the prepared active silicate solution was added at a rate of 1.5 g/min to prepare a seed solution. The average primary particle size of seed particle aggregate in the seed solution was 184 nm.

Then, after 0.9 g of 28% ammonia aqueous solution was added to stabilize the seed solution, 550 g of the prepared active silicate solution was added to the mixture at a rate of 1.5 g/min while maintaining the temperature of 100° C. After the addition was completed, the mixture was refluxed for 9 hours at 100° C. to concentrate the mixture, and a silica fine particle dispersion of 10% by mass was obtained. The average primary particle size, the average secondary particle size, the specific surface area, and the pore volume of the silica fine particle were 11 nm, 130 nm, 257 m²/g, and 1.01 ml/g, respectively.

(Preparation of Coating Solution C for Ink Receiving Layer)

To 1,000 parts of the 10% by mass silica fine particle dispersion obtained as above, 20% by mass aqueous solution of 50 mol % methoxycarbonyl denatured polyallylamine hydrochloride (40 parts, molecular weight of about 15,000) was added. The solution was dispersed using an agitating device, and the mixture was treated using a wet type nanomizer. Then, 5% by mass aqueous solution of polyvinyl alcohol (389 parts, trade name: PVA-145, a product of Kuraray Co., Ltd., saponification degree of 99%, and average polymerization degree of 4,500) and a small amount of antifoaming agent, dispersing agent and water were added. As a result, a coating solution C for ink receiving layer having a solid component concentration of 8% by mass was obtained.

(Preparation of Ink Jet Recording Sheet)

The coating solution B for ink receiving layer was applied onto a paper supporting medium in which both surfaces of 180 g/m² base paper were coated by polyethylene resin (thickness of 240 μm, and the polyethylene resin included 15% by mass of anatase titanium dioxide) using a wired bar so that the solid component contained in the coating solution B became 20 g/m², and this was dried to prepare an ink receiving layer B. Then, 0.5% by mass borax aqueous coating solution was applied so as to be 20 g/m², and the coating solution C for ink receiving layer was applied thereon using a wired bar and dried so that the solid component contained in the coating solution C became 7 g/m to obtain an ink jet recording sheet.

### Example 14

After 1% by mass borax aqueous coating solution 20 g/m was applied onto a paper supporting medium in which both surfaces of 180 g/m² base paper were coated by polyethylene resin (thickness of 240 μm, and the polyethylene resin included 15% by mass of anatase titanium dioxide), the coating solution A for ink receiving layer was applied thereon using a wired bar and dried so that the solid component contained in the coating solution A became 20 g/m² to obtain ink jet recording sheet.

### Example 15

(Preparation of Coating Solution D for Ink Receiving Layer)

Vapor phase silica (100 parts, trade name: Aerosil 300, a product of Aerosil Co.), 30% by mass aqueous solution of N-vinyl acrylamidine hydrochloride.acrylamide copolymer (50 parts, molar ratio of 2:1, and molecular weight of about 20,000), and ion exchanged water (850 parts) were mixed and dispersed using an agitating device, and the mixture was treated using a wet type nanomizer. Then, 5% by mass aqueous solution of polyvinyl alcohol (360 parts, trade name: PVA-145, a product of Kuraray Co., Ltd., saponification degree of 99%, average polymerization degree of 4,500) and a small amount of antifoaming agent, dispersing agent and water were added. As a result, a coating solution D for ink receiving layer having a solid component concentration of 8% was obtained.

(Preparation of Ink Jet Recording Sheet)

The coating solution B for ink receiving layer was applied onto a paper supporting medium in which both surfaces of 180 g/m² base paper were coated by polyethylene resin (thickness of 240 μm, and the polyethylene resin included 15% by mass of anatase titanium dioxide) using a wired bar so that the solid component contained in the coating solution B became 20 g/m², and this was dried to prepare an ink receiving layer B. Then, aqueous solution (1:5 mixed solution, concentration of 3% by mass) of borax-50 mol % methoxycarbonyl denatured polyallylamine hydrochloride (molecular weight of about 15,000) was applied so as to be 20 g/m², and the coating solution D for the ink receiving layer was applied thereon using a wired bar and dried so that the solid component contained in the coating solution D became 7 g/m² to obtain an ink jet recording sheet.

### Example 16

An ink jet recording sheet was prepared in the same manner as in Example 15 except that 50 mol % acetyl denatured polyallylamine hydrochloride (molecular weight of about 20,000) was used instead of 50 mol % methoxycarbonyl denatured polyallylamine hydrochloride.

### Examples 17-18

An ink jet recording sheet was prepared in the same manner as in Example 1 except that the following compound was used instead of 50 mol % methoxycarbonyl denatured polyallylamine hydrochloride (molecular weight of about 15,000):

In Example 17: 70 mol % methoxycarbonyl denatured polyallylamine hydrochloride (molecular weight of about 15,000): and

In Example 18: 20 mol % methoxycarbonyl denatured 50 mol % hydrochloride polyallylamine (molecular weight of about 15,000).

### Example 19

An ink jet recording sheet was prepared in the same manner as in Example 1 except that the following compound was further added to the coating solution A for ink receiving layer:

10% by mass aqueous solution (20 parts) of copolymer 1 shown below (molecular weight of about 15,000, 1: m=2:1): 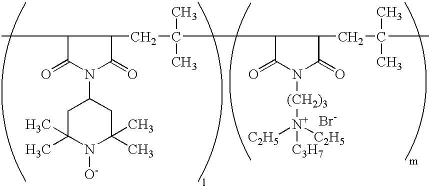
wherein 1 and m each represents an integer.

### Example 20

An ink jet recording sheet was prepared in the same manner as in Example 19 except that the following copolymer 2 having the same structural unit as the above-mentioned copolymer 1 was used instead of the copolymer 1:

10% by mass aqueous solution (20 parts) of copolymer 2 (molecular weight of about 15,000, 1: m=1:1).

### Examples 21-22

An ink jet recording sheet was prepared in the same manner as in Example 18 except that the following compound was further added to the coating solution A for ink receiving layer:

In Example 21: 20 parts of 10% by mass aqueous solution of copolymer 1; and

In Example 22: 20 parts of 10% by mass aqueous solution of copolymer 2.

### Example 23

(Preparation of Coating Solution E for Glossy Layer)

Vapor phase oxidized alumina fine particles (100 parts, trade name: PG003, a product of CABOT Co.), polyvinyl alcohol (5 parts, trade name: PVA-135, a product of Kuraray Co., Ltd., saponification degree of 98.5%, polymerization degree of 3,500) as a binder and stearate amide (3 parts) were mixed to prepare a 5% by mass coating solution E for glossy layer.

(Preparation of Ink Jet Recording Sheet)

Immediately after the coating solution E for glossy layer was applied onto the ink receiving layer formed in Example 1 using a wire bar, a glossy layer E was formed by pressure welding it to a specular surface drum having a surface temperature of 95° C., drying, and separating to obtain an ink jet recording sheet. The coating amount of the glossy layer E in terms of solid components was 2 g/m².

### Examples 24

(Preparation of Coating Solution F for Ink Receiving Layer)

A coating solution F for ink receiving layer having a solid component concentration of 15% by mass was obtained by mixing wet process amorphous silica (100 parts, trade name: Finesil X-30, a product of Tokuyama Corporation), 10% aqueous solution of silicon denatured polyvinyl alcohol (200 parts, trade name: R-1130, a product of Kuraray Co., Ltd., saponification degree of 98.5%, and average polymerization degree of 3,000), and a small amount of antifoaming agent, dispersing agent and water.

(Preparation of Coating Solution G for Ink Receiving Layer)

Vapor phase silica (100 parts, trade name: Aerosil 300, a product of Aerosil Co.), 20% by mass aqueous solution of 50 mol % methoxycarbonyl denatured polyallyl amine hydrochloride (100 parts, molecular weight of about 15,000), and ion exchanged water (800 parts) were mixed and dispersed using an agitating device, and the mixture was treated using a wet type nanomizer. Then, 10% by mass aqueous solution of polyvinyl alcohol (200 parts, trade name: PVA-117, a product of Kuraray Co., Ltd., saponification degree of 98.5%, and average polymerization degree of 1,700) and a small amount of antifoaming agent, dispersing agent and water were added. As a result, a coating solution G for ink receiving layer having a solid component concentration of 10% by mass was obtained.

(Preparation of Coating Solution H for Glossy Layer)

A coating solution H for glossy layer having a solid component concentration of 5% by mass was obtained by mixing a complex of styrene-2-hexyl acrylate copolymer and colloidal silica (100 parts, glass transition temperature of 75° C., and mass ratio of the copolymer and colloidal silica of 20:8), 5 parts of alkylvinyl ether.maleic acid derivative copolymer, 3 parts of stearyl potassium phosphate, 25 parts of polyethylene wax, and 5 parts of casein.

(Preparation of Ink Jet Recording Sheet)

The coating solution F for ink receiving layer was applied onto 200 g/m² of woodfree paper using a wired bar so that the solid component contained in the coating solution F became 10 g/m², and this was dried. Then, the coating solution G for ink receiving layer was applied using a wired bar so that the solid component contained in the coating solution G became 5 g/m², and this was dried to prepare an ink receiving layer G Also, immediately after the coating solution H for glossy layer was applied using a wired bar, it was press welded to a specular surface drum, the surface temperature thereof was 95° C., dried, and separated therefrom to obtain an ink jet recording sheet having a glossy layer H. The coated amount of the glossy layer H was 2 g/m² converted to solid component.

### Examples 25-26

An ink jet recording sheet was prepared in the same manner as in Example 24 except that the following compound was used instead of 50 mol % methoxycarbonyl denatured polyallyl amine hydrochloride:

In Example 25: 20 mol % methoxycarbonyl denatured polyallylamine (molecular weight of about 15,000); and

In Example 26: 50 mol % acetyl denatured polyallylamine hydrochloride (molecular weight of about 15,000).

### Example 27

(Preparation of Coating Solution I for Ink Receiving Layer)

Vapor phase silica (100 parts, trade name: Aerosil 300, a product of Aerosil Co.), 20% by mass aqueous solution of 50 mol % acetyl denatured polyallylamine hydrochloride (150 parts, molecular weight of about 15,000), and ion exchanged water (750 parts) were mixed and dispersed using an agitating device, and the mixture was treated using a wet type nanomizer. Then, 25% by mass aqueous solution of cationic polyurethane resin (120 parts, trade name: F-8564D, a product of Dai-ichi Kogyo Seiyaku Co., Ltd., Tg of 73° C.), 10 parts of polyethylene wax, and a small amount of antifoaming agent, dispersing agent and water were added. As a result, a coating solution I for ink receiving layer having a solid component concentration of 10% was obtained.

(Preparation of Ink Jet Recording Sheet)

The coating solution F for ink receiving layer was applied onto 200 g/m² of woodfree paper using a wired bar so that the solid component contained in the coating solution F became 10 g/m², and this was dried to prepare an ink receiving layer F. Then, the coating solution I for ink receiving layer was applied using a wired bar so that the solid component contained in the coating solution I became 5 g/m². Immediately after this, it was press welded to a specular surface drum, the surface temperature thereof was 90° C., dried, and separated therefrom to obtain ink jet recording sheet having an ink receiving layer I.

### Comparative Examples 1-3

Ink jet recording sheet was prepared in the same manner as in Example 1 except that the following compound was used instead of 50 mol % acetyl denatured polyallylamine hydrochloride (molecular weight of about 15,000):

In Comparative Example 1: polyallylamine hydrochloride (molecular weight of about 100,000);

In Comparative Example 2: polydiallylamine hydrochloride (molecular weight of about 50,000); and

In Comparative Example 3: polydimethyldiallyl ammonium chloride (molecular weight of about 200,000).

### Comparative Example 4

An ink jet recording sheet was prepared in the same manner as in Example 15 except that 0.5% by mass borax aqueous solution was used instead of aqueous solution (1:5 mixed solution, concentration of 3% by mass) of borax-50 mol % acetyl denatured polyallylamine hydrochloride (molecular weight of about 15,000).

### Comparative Examples 5-7

An ink jet recording sheet was prepared in the same manner as in Example 24 except that the following compound was used instead of 50 mol % acetyl denatured polyallylamine hydrochloride (molecular weight of about 15,000):

In Comparative Example 5: polyallylamine hydrochloride (molecular weight of about 100,000);

In Comparative Example 6: polydiallylamine hydrochloride (molecular weight of about 50,000); and

In Comparative Example 7: polydimethyldiallyl ammonium chloride (molecular weight of about 200,000).

Evaluation Method 1:

Using an ink jet recording sheet obtained by Examples 1 to 23 and Comparative Examples 1 to 4, ISO-400 image (refer to “Highly Fine Color Digital Standard Image Data ISO/JIS-SCID”, p. 13, Image Title: Portrait, issued by Japanese Standards Association) was printed using Epson Ink jet printer PM-950C (dye ink type printer) and solid printing was carried out so that the optical density of composite black became 1.0.

The following evaluations were made for the obtained ink jet recording sheet, and the results are shown in the following Table 1.

(Glossiness)

Glossiness of a coated surface of unprinted portion of ink jet recording sheet was visually observed and evaluated.

(Evaluation Standard):
⊚: excellent glossiness;
◯: good glossiness;
Δ: somewhat inferior glossiness; and
X: almost no glossiness.
   (Cracks)

Cracks on a coated surface of unprinted portion of ink jet recording sheet was visually observed and evaluated.

(Evaluation Standard):
⊚: absolutely no cracks;
◯: a few cracks but practically no problem;
Δ: cracks and practically problematic; and
X: numerous cracks.
   (Ink Absorption)

Obtained ISO-400 image was visually observed, and ink absorption of each was evaluated.

(Evaluation Standard):
⊚: absolutely no crushing of image due to ink overflow;
◯: slight crushing of image due to ink overflow but practically no problem;
Δ: crushing of image due to ink overflow and practically problematic; and
X: numerous crushing of image due to ink overflow.
   (Image Quality)

Obtained ISO-400 image was visually evaluated, and image quality of each was evaluated.

(Evaluation Standard):
⊚: excellent image quality;
◯: good image quality and practically no problem;
Δ: inferior image quality and practically problematic; and
X: bad image quality.
   (High Temperature and Humidity Resistance)

Obtained ISO-400 image and solid printing image of composite black were left for 24 hours, and then kept under an atmosphere of 40° C. and relative humidity of 90% for 72 hours. After this, the level of high temperature and humidity resistance was visually observed and evaluated.

(Evaluation Standard):
⊚: almost no generation of time-lapse feathering and color fading was observed;
◯: generation of some time-lapse feathering and color fading but practically no problem;
Δ: generation of time-lapse feathering and color fading and practically problematic; and
X: generation of numerous time-lapse feathering and significant color fading.
   (Light Resistance)

Obtained image and solid printing image of composite black were left for 24 hours, and then kept under an atmosphere of 63° C. and relative humidity of 40% for 48 hours using a xenon weather meter (“WEL-7X-LHP”, a product of Suga Shikenki Co., Ltd.) After this, the level of light resistance was visually observed and evaluated.

(Evaluation Standard):
⊚: almost no generation of color fading was observed;
◯: generation of some color fading but good in color balance;
Δ: generation of color fading and practically problematic; and
X: generation of significant color fading.

As for the solid printing image of composite black, the optical density before and after the test was measured using a Macbeth reflection density measuring device RD-914, and the remaining rate, i.e., optical density after the test/optical density before the test×100 (%), was obtained.

(Printability for Pigment Ink and Abrasion Resistance of Image Formed by Pigment Ink)

Using ink jet recording sheets obtained by Examples 1 to 23 and Comparative Examples 1 to 4, ISO-400 image (refer to “Highly Fine Color Digital Standard Image Data ISO/JIS-SCID”, p. 13, Image Title: Fruit basket, issued by Japanese Standards Association) was printed using Epson Ink jet printer PM-G900 (pigment ink type printer, total content of 1,2-hexane diol and glycerin is 80% by mass or more) to evaluate the printability for pigment ink and the abrasion resistance of images formed by pigment ink.

(a) Printability of Pigment Ink

The printability of pigment ink was evaluated based on the uniformity of an image:
⊚: uniform image and no spot was observed;
◯: some spots were observed, but practically no problem;
Δ: some spots were observed but practically acceptable; and
X: numerous spots were observed and practically unusable.
   (b) Abrasion Resistance of Image Formed by Pigment Ink

Immediately after the above-mentioned image was recorded, the image portion was strongly rubbed using gauze, and the abrasion resistance thereof was evaluated as follows:
⊚: no change in the image portion;
◯: a part of pigment of the image portion was removed but practically no problem; and
X: significant amount of pigment of the image portion was removed and practically problematic.
   Evaluation Method 2:

Using ink jet recording sheets obtained by Examples 24 to 27 and Comparative Examples 5 to 7, ISO-400 image (refer to “Highly Fine Color Digital Standard Image Data ISO/JIS-SCID”, p. 13, Image Title: Portrait, issued by Japanese Standards Association) was printed using Epson Ink jet printer PM-950C and solid printing was carried out so that the optical density of composite black became 1.0.

The above-mentioned evaluations of “glossiness”, “image quality”, “heat and humidity resistance”, and “light resistance”, were made for the obtained ink jet recording sheet, and the results are shown in the following Table 2.

TABLE 1

| | | | Ink | Image | Temp. & humid. | Light resistance | |
|---|---|---|---|---|---|---|---|
| | Glossiness | Cracks | absorption | quality | resistance | Image | Remaining rate |
| Ex. 1 | ⊚ | ⊚ | ⊚ | ⊚ | ⊚ | ⊚ | 85 |
| Ex. 2 | ⊚ | ⊚ | ◯ | ◯ | ◯ | ⊚ | 83 |
| Ex. 3 | ⊚ | ⊚ | ⊚ | ⊚ | ⊚ | ⊚ | 82 |
| Ex. 4 | ⊚ | ⊚ | ⊚ | ⊚ | ⊚ | ⊚ | 80 |
| Ex. 5 | ◯ | ⊚ | ⊚ | ⊚ | ⊚ | ◯ | 75 |
| Ex. 6 | ⊚ | ⊚ | ⊚ | ⊚ | ⊚ | ⊚ | 82 |
| Ex. 7 | ⊚ | ◯ | ◯ | ◯ | ◯ | ◯ | 75 |
| Ex. 8 | ◯ | ◯ | ◯ | ◯ | ⊚ | ◯ | 73 |
| Ex. 9 | ◯ | ◯ | ◯ | ◯ | ⊚ | ◯ | 76 |
| Ex. 10 | ⊚ | ⊚ | ⊚ | ⊚ | ⊚ | ⊚ | 84 |
| Ex. 11 | ◯ | ◯ | ◯ | ◯ | ⊚ | ◯ | 77 |
| Ex. 12 | ◯ | ◯ | ◯ | ◯ | ⊚ | ◯ | 75 |
| Ex. 13 | ⊚ | ⊚ | ⊚ | ⊚ | ⊚ | ⊚ | 84 |
| Ex. 14 | ⊚ | ◯ | ⊚ | ⊚ | ⊚ | ⊚ | 83 |
| Ex. 15 | ⊚ | ⊚ | ⊚ | ⊚ | ⊚ | ◯ | 74 |
| Ex. 16 | ⊚ | ⊚ | ⊚ | ⊚ | ⊚ | ◯ | 72 |
| Ex. 17 | ⊚ | ⊚ | ⊚ | ⊚ | ◯ | ⊚ | 84 |
| Ex. 18 | ⊚ | ⊚ | ⊚ | ⊚ | ⊚ | ⊚ | 86 |
| Ex. 19 | ⊚ | ⊚ | ◯ | ⊚ | ⊚ | ⊚ | 93 |
| Ex. 20 | ⊚ | ⊚ | ◯ | ⊚ | ⊚ | ⊚ | 91 |
| Ex. 21 | ⊚ | ⊚ | ⊚ | ⊚ | ⊚ | ⊚ | 94 |
| Ex. 22 | ⊚ | ⊚ | ⊚ | ⊚ | ⊚ | ⊚ | 92 |
| Ex. 23 | ⊚ | ⊚ | ⊚ | ⊚ | ⊚ | ⊚ | 85 |
| C. Ex. 1 | Δ | Δ | Δ | Δ | Δ | X | 42 |
| C. Ex. 2 | Δ | Δ | Δ | Δ | X | Δ | 65 |
| C. Ex. 3 | Δ | Δ | Δ | ◯ | X | X | 50 |
| C. Ex. 4 | Δ | Δ | Δ | ◯ | X | X | 56 |

Pigment ink printability

| | Ink printability | Abrasion resistance |
|---|---|---|
| Ex. 1 | ◯ | ◯ |
| Ex. 2 | ◯ | ◯ |
| Ex. 3 | ◯ | ◯ |
| Ex. 4 | ◯ | ◯ |
| Ex. 5 | ◯ | ◯ |
| Ex. 6 | ◯ | ◯ |
| Ex. 7 | ◯ | ◯ |
| Ex. 8 | ◯ | ◯ |
| Ex. 9 | ◯ | ◯ |
| Ex. 10 | ◯ | ◯ |
| Ex. 11 | ◯ | ◯ |
| Ex. 12 | ◯ | ◯ |
| Ex. 13 | ◯ | ◯ |
| Ex. 14 | ◯ | ◯ |
| Ex. 15 | ◯ | ◯ |
| Ex. 16 | ◯ | ◯ |
| Ex. 17 | ◯ | ◯ |
| Ex. 18 | ◯ | ◯ |
| Ex. 19 | ◯ | ◯ |
| Ex. 20 | ◯ | ◯ |
| Ex. 21 | ◯ | ◯ |
| Ex. 22 | ◯ | ◯ |
| Ex. 23 | ⊚ | ⊚ |
| C. Ex. 1 | ◯ | ◯ |
| C. Ex. 2 | ◯ | ◯ |
| C. Ex. 3 | ◯ | ◯ |
| C. Ex. 4 | ◯ | ◯ |

TABLE 2

| | | | | Light resistance | |
|---|---|---|---|---|---|
| | | Image | Temp. & humid. | | Remaining |
| | Glossiness | quality | Resistance | Image | rate |
| Ex. 24 | ◯ | ◯ | ⊚ | ⊚ | 87 |
| Ex. 25 | ◯ | ◯ | ⊚ | ⊚ | 85 |
| Ex. 26 | ◯ | ◯ | ⊚ | ⊚ | 81 |
| Ex. 27 | ◯ | ◯ | ⊚ | ⊚ | 84 |
| C. Ex. 5 | Δ | Δ | Δ | X | 52 |
| C. Ex. 6 | Δ | Δ | X | Δ | 66 |
| C. Ex. 7 | Δ | ◯ | Δ | X | 50 |

As is obvious from the Tables 1 and 2 above, the ink jet recording sheet of Examples 1 to 27 of the present invention were excellent in that high quality images were formed, almost no time-lapse feathering and color fading were observed even under the high temperature and high humidity environment, almost no color fading occurred even exposed to light for a long period of time, and superb long-term preservability was obtained.

Also, from the viewpoint of a supporting medium, the ink jet recording sheet of Examples 1 to 23 in which a water resistant supporting medium was used, was excellent in terms of glossiness, cracks and ink absorptivity, as shown in Table 1. Among these, the ink jet recording sheet of Examples 15 and 16 in which the aqueous solution including borax and cationic polymer was applied, showed particularly excellent results in all of the glossiness, cracks, ink absorptivity, and image quality evaluation.

Moreover, as for the ink jet recording sheet of Example 23 of the present invention in which fumed alumina was formed, not only was the glossiness improved but also pigment ink printability was excellent.

Furthermore, the ink jet recording sheet of Examples 19 to 22 of the present invention in which a hindered amine type photo stabilizer was added to the ink receiving layer, were excellent for glossiness, crack prevention, image quality, and heat and humidity resistance, and were also excellent for the light resistance (of image and remaining rate).

As described above, the present invention may be applied to an ink jet recording sheet including a supporting medium and an ink receiving layer disposed on the supporting medium, in which inorganic fine particle, cation polymer and binder are contained. According to the present invention, in particular, an ink jet recording sheet which is suitable for dye ink or pigment ink type ink jet printer whose ink discharge speed is high to produce image quality at a photographic level.

Having thus described exemplary embodiments of the invention, it will be apparent that various alterations, modifications, and improvements will readily occur to those skilled in the art. Such alterations, modifications, and improvements, though not expressly described above, are nonetheless intended and implied to be within the spirit and scope of the invention. Accordingly, the foregoing discussion is intended to be illustrative only: the invention is limited and defined only by the following claims and equivalents thereto.

1. Ink jet recording sheet, comprising:
a supporting medium; and
an ink receiving layer which includes an inorganic fine particle, a cationic polymer, and a binder, the ink receiving layer being disposed on the supporting medium,
wherein an average primary particle size of the inorganic fine particle is 30 nm or less, and the cationic polymer is a polymer (A) comprising: at least one structural unit (a1) expressed by a following general formula (1) or (2): 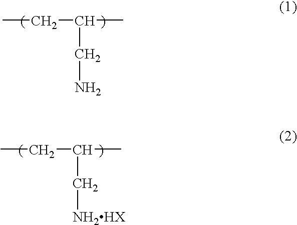
wherein X represents an acid residue; and at least one structural unit (a2) expressed by a following general formula (3): 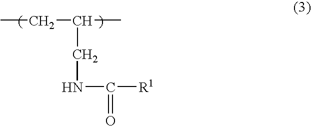
wherein R¹ represents a C₁₋₁₈ alkyl group, C₁₋₁₈ alkoxy group, C₆₋₁₂ aryl group, or benzyl group.

2. The ink jet recording sheet according to claim 1, wherein the molar ratio of the structural unit (a1) to the structural unit (a2) in the polymer (A) is within a range of 0.5:1 to 20:1.

3. The ink jet recording sheet according to claim 1, further including at least one structural unit (a3) expressed by following general formula (4), (5), (6) or (7): 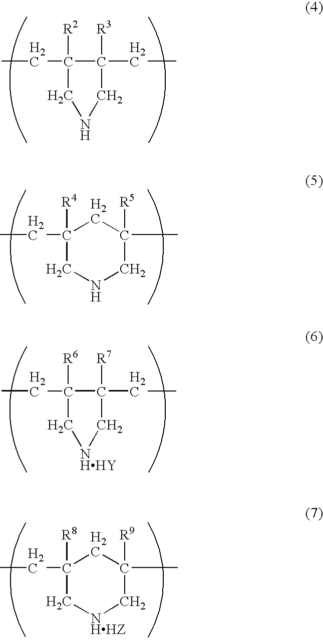
wherein R² to R⁹ each independently represents a hydrogen atom or an alkyl group having a number of carbon atoms of 1 to 4, and Y and Z independently represents an acid residue.

4. The ink jet recording sheet according to claim 3, wherein a molar ratio of a total of the structural unit (a1) and the structural unit (a2) to the structural unit (a3) is 0.5:1 to 5:1.

5. The ink jet recording sheet according to claim 3, wherein R² to R⁹ in the above general formulae (4), (5), (6) and (7) all represent hydrogen atoms.

6. The ink jet recording sheet according to claim 1, wherein a molecular weight of the polymer (A) is within a range between 10,000 and 200,000.

7. The ink jet recording sheet according to claim 1, wherein the inorganic fine particle is a vapor phase silica.

8. The ink jet recording sheet according to claim 1, wherein the inorganic fine particle is a wet process fine silica prepared by condensing active silicate.

9. The ink jet recording sheet according to claim 8, wherein a specific surface area measured by a BET method and a pore volume of the wet process fine silica is 100 to 400 m²/g and 0.5 to 2.0 ml/g, respectively.

10. The ink jet recording sheet according to claim 1, wherein the ink receiving layer further includes a cross-linking agent.

11. The ink jet recording sheet according to claim 10, wherein the cross-linking agent includes a boron compound.

12. The ink jet recording sheet according to claim 11, wherein a mass ratio of the boron compound to the polymer (A) in the ink receiving layer is 1:1 to 1:10.

13. The ink jet recording sheet according to claim 1, wherein the ink receiving layer further includes a hindered amine photostabilizer containing a polymer (B) comprising: at least one structural unit (b1) expressed by the following general formula (8) and at least one structural unit (b2) expressed by the following general formula (9) and/or (10): 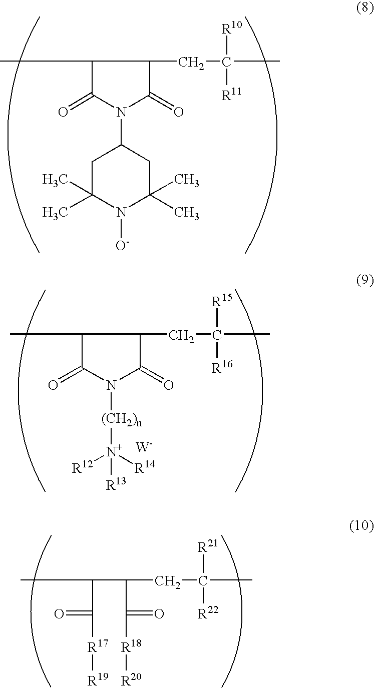
wherein R¹⁰, R¹¹, R¹⁵, R¹⁶, R²¹, and R²² each independently represents a hydrogen atom or a C₁₋₈ alkyl group; R¹² to R¹⁴ each independently represents a C₁₋₈ alkyl group; W represents an acid residue; n represents an integer of 1 to 6; R¹⁷ and R¹⁸ each independently represents an oxygen atom or a N—R²³ where R²³ is a hydrogen atom or a C₁₋₈ alkyl group; and R¹⁹ and R²⁰ each independently represents a hydrogen atom or a C₁₋₈ alkyl group.

14. The ink jet recording sheet according to claim 13, wherein the structural unit (b2) is expressed by the following general formula (11): 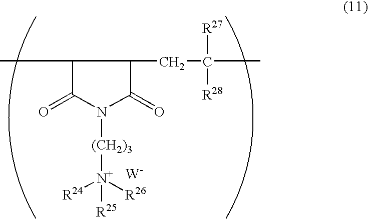
wherein R²⁷ and R²⁸ each independently represents a hydrogen atom or a methyl group; R²⁴ to R²⁶ each independently represents a C₁₋₃ alkyl group; and W represents an acid residue.

15. The ink jet recording sheet according to claim 1, wherein the supporting medium is a water resistant supporting medium.

16. The ink jet recording sheet according to claim 15, wherein the water resistant supporting medium is a paper medium both surfaces of which is coated by a polyolefin resin.

17. The ink jet recording sheet according to claim 1, wherein the ink receiving layer is subjected to a cast process.

18. The ink jet recording sheet according to claim 1, further comprising: a glossy layer which is disposed on the ink receiving layer.

19. The ink jet recording sheet according to claim 1, wherein the ink receiving layer is made of a plurality of layers comprising: at least one inside layer including an inorganic fine particle and a binder; at least one aqueous coating layer formed on the inside layer by applying an aqueous solution including a cationic polymer on the inside layer; and at least one outside layer disposed on the aqueous coating layer.

20. The ink jet recording sheet according to claim 19, wherein the aqueous solution further includes a cross-linking agent.

21. The ink jet recording sheet according to claim 19, wherein the cation polymer is the polymer (A).
